(19) United States
(12) Patent Application Publication
(10) Pub. No.: US 2021/0348930 A1
(43) Pub. Date: Nov. 11, 2021

(54) System and Methods for Identifying Obstructions and Hazards Along Routes

(71) Applicant: Google LLC, Mountain View, CA (US)

(72) Inventors: Joseph Johnson, Jr., Seattle, WA (US); Shiblee Hasan, Santa Clara, CA (US); Chris Hluchan, Arvada, CO (US); David Lee, Cupertino, CA (US)

(21) Appl. No.: 17/273,220

(22) PCT Filed: Mar. 10, 2020
(86) PCT No.: PCT/US2020/021843

§ 371 Date: Mar. 3, 2021

(51) Int. Cl. G01C 21/34; G06F 16/901; G01C 21/36

(52) U.S. Cl. CPC G01C 21/3415; B60W 60/001; G01C 21/3691; G06F 16/901

(57) ABSTRACT

The present disclosure is directed towards systems and methods for receiving environmental data from device sensors. A computing system stores environmental data in an environmental feature database at the computing system for a plurality of geographic locations. The computing system receives, from one or more remote systems, data indicating one or more environmental features for a particular geographic location. The computing system accesses stored environmental data for the particular geographic location to determine whether the environmental features are included in the environmental feature database. In response to determining that the environmental features are included in the environmental feature database, the operations further comprise, updates a confidence value associated with the environmental features. In response to determining that the one or more environmental features are not included in the environmental feature database, the computing system adds the environmental feature to the environmental feature database in associated a geographic location.

### FIELD

The present disclosure relates generally to using sensor data to identify features of an environment. More particularly, the present disclosure relates to improving map data by analyzing sensor data that was initially gathered for another purpose.

### BACKGROUND

Modern computing devices come equipped with a variety of sensors. These sensors can gather data that is used to perform a variety of tasks including, but not limited to, capturing image data, verifying a user's identity, detecting hand motions, communicating over a network, providing augmented reality experiences, and so on. Once this sensor data has been gathered it can be used for other purposes.

### SUMMARY

Aspects and advantages of embodiments of the present disclosure will be set forth in part in the following description, or can be learned from the description, or can be learned through practice of the embodiments.

One example aspect of the present disclosure is directed towards a system for receiving environmental data from device sensors. The computing system comprising one or more processors and a non-transitory computer-readable memory. The non-transitory computer-readable memory stores instructions that, when executed by the processor, cause the computing system to perform operations. The operations comprise storing environmental data in an environmental feature database at the computing system for a plurality of geographic locations. The operations further comprise receiving, from one or more remote systems, data indicating one or more environmental features for a particular geographic location. The operations further comprise accessing stored environmental data for the particular geographic location to determine whether the one or more environmental features are included in the environmental feature database. The operations further comprise, in response to determining that the one or more environmental features are included in the environmental feature database, updating a confidence value associated with the one or more environmental features. The operations further comprise, in response to determining that the one or more environmental features are not included in the environmental feature database, adding the environmental feature to the environmental feature database in associated with the particular geographic location.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example computing environment for a feature detection system according to example embodiments of the present disclosure.

FIG. 2 depicts an example client-server environment according to example embodiments of the present disclosure.

FIG. 3 depicts a block diagram of a feature detection system according to example embodiments of the present disclosure.

FIG. 4 depicts a block diagram of a remote system according to example embodiments of the present disclosure.

FIG. 5 depicts a flow chart of an example method for identifying features in an environment according to example embodiments of the present disclosure.

FIG. 6 depicts a flow chart of an example method for managing a map database according to example embodiments of the present disclosure.

Reference numerals that are repeated across plural figures are intended to identify the same features in various implementations.

### DETAILED DESCRIPTION

Generally, the present disclosure is directed to a system for identifying relevant environmental features by analyzing data gathered by sensors that are primarily used for other purposes. In general, computing devices can be associated with one or more sensors. The sensors gather data concerning the environment of the computing device. Each device can gather data for one or more primary uses. However, once this data has been gathered, it can be analyzed to determine whether additional information can be extracted from the sensor data. For example, a user device (e.g. a smartphone) can have a plurality of sensors that are used for specific tasks. One such task is the passive monitoring of RADAR sensor data to detect gestures of a user (e.g., hand gestures) near the smartphone. These sensors are not primarily being used to generate information about hazards in an environment. However, with the user's permission, the data gathered by the RADAR sensors can be analyzed to detect one or more features of the surrounding environment. For example, the data generated by the RADAR sensors can be analyzed to identify irregularities with nearby roads or sidewalks (e.g., potholes, broken segments, and so on). This environmental information can be gathered at a central server system and used to update a database of road data (e.g., associated with a navigation system), send updates to users, and notify public officials of potential issues. This environmental information can be associated with a confidence level and the confidence level can be increased or decreased as more data is received from other user devices.

More particularly, a feature detection system (e.g., a computing system that includes one or more processors and memory) can administer a database of geographic information for a plurality of geographic locations. The database can include geographic data associated with geographic locations and their environments. The geographic data can include data describing roads, buildings, landmarks, traffic information, and other data useful for navigating through geographic space. In some examples, the database can include one or more environmental features. Geographic features can include objects, hazards, crowds of people, states of traffic, information describing current weather, the shape, location, and layout of the interior of a building, and so on.

The geographic data can also include information describing a current crowd size and temperament at the geographic location, the maintenance needs of one or more structures at the geographic location, and the operational hours of one or more businesses near or at the geographic location. A current geographic database can include additional data (e.g., map data) associated with the geographic location including data used to navigate. In some examples, each particular environmental feature in the geographic database can be associated with a particular confidence level. The confidence level can represent the degree to which the system is confident that the particular environmental feature indeed exists at the location for which it is listed.

The feature detection system can receive data from one or more remote systems. As data is received from one or more remote systems, the feature detection system can update the data in the geographic database. In some examples, the remote systems are user computing devices associated with users such as smartphones, tablet computers, wearable electronics, or computer systems associated with vehicles.

The remote systems can be one of a smartphone, a tablet computer, a wearable computing device such as a smartwatch or a health monitor, or any other computing device that can include one or more sensors. In some examples, the remote system can be a computing system associated with a vehicle (e.g., human-controlled or self-driving/autonomous) with one or more sensors for navigation through an environment. In some examples, the remote system can be a computing device carried in a backpack used to generate information for the interior of buildings.

Each remote system can include one or more sensors, each sensor having a sensor type. Each sensor is included in the remote system for a primary purpose. For example, the remote system can be a smartphone that includes a camera. The camera associated with a smartphone can have the primary purpose of capturing image data or video data as directed by a user. Another purpose can include using facial recognition to verify the identity of a user before allowing the user to unlock the smartphone.

Other sensors that may be included on a smartphone can include a microphone for capturing audio data and a RADAR sensor for sensing nearby hand motions of a user that can allow the user to control the smartphone. In another example, the remote system is a vehicle that includes a plurality of sensors including a LIDAR sensor that allows the vehicle to capture data about objects in the environment of the vehicle.

The remote devices can use the data captured from the sensors for a first use. For example, as noted above, a user can use the camera on their smartphone to take a selfie. In some examples, the primary use of the captured sensor data may include launching an application associated with the first use. For example, the user may launch a camera application to use the camera to capture image data or video data.

The first (or primary) use of the sensor data may not involve explicitly launching an application. Instead, the first use of the sensor data may be associated with passively monitoring the data captured by the sensor and monitoring that data for one or more situations in which the smartphone or other device needs to respond. For example, a smartphone may include a RADAR sensor. The RADAR sensor can constantly monitor the motion of objects near the smartphone and determine when or if a user is making a hand gesture associated with unlocking the device. For example, a user may make one or more hand gestures near the smartphone. A particular hand gesture can, for example, be associated with unlocking the smartphone for use.

Another example of a first use can be an augmented reality application. Using such an application, a camera associated with a computing device is active and can capture image data of the environment around the device so that a view of the environment, shown on a display associated with a device, can be altered such that objects not present in the environment appear. The image data being captured by the camera can include a view of a road surface or other features of the environment. As a result, this data can be analyzed to determine whether any environmental features can be identified.

Similarly, another first use can passively monitor audio data using a microphone to enable the use of voice commands from a user to control the computing device. This audio data can be analyzed to determine sound levels in the environment. These sound levels can be analyzed to estimate crowd sizes and determine the status of businesses (e.g., open, closed, busy, and so on).

A computing device can also include a transceiver for wireless signals (e.g., a WIFI signal) which allows the computing device to communicate via a network. In some examples, the wireless signals can be body reflective and thus can be analyzed to determine the number of individuals in a given area.

In some examples, camera data can be analyzed to determine health data for individuals within the environment of the computing device. For instance, photoplethysmography (PPG) can be used to detect and measure the heart rate of people with some accuracy through RGB images (e.g., that can be captured by a camera). In some examples, this information can be associated with a specific location. This data, when properly anonymized, crowd-sourced, and privatized, can be used to aide in the understanding of health experiments/studies/datasets where, for instance, average heart rate is a useful statistic to know at various times of day, year/season, location, and/or with/without knowledge of various activities going on nearby. In some examples, the elevated heart-rate can be analyzed and used as an indication of the presence of a potential disturbance, road condition, and so on (from an otherwise stressful commuting or pedestrian event).

Once the data has been used for the first use of the remote computing device, the data may also be used for a secondary purpose. For example, data gathered for a first purpose can later be analyzed to determine whether any environmental features can be determined based on the data. In some examples, the sensor data can be transmitted to a feature detection system that is remote from the user device. However, transmitting raw sensor data can consume so much bandwidth or take so much time that it is not feasible to transmit all the raw sensor data. As such the remote system itself can include the ability to analyze sensor data for the second use and determine any environmental features that may be locatable.

The remote computing devices can take measures to ensure the privacy of the users including the owners of the remote computing devices and any persons or property in the environment of a remote computing device. For example, the remote computing device can remove any personally identifiable information from data captured by sensors. Thus, the data transferred to a central server will not include information that can identify any particular person. Furthermore, information can be received from a plurality of remote systems, such that the crowd-sourced data provides additional privacy because the contributions of any particular remote system can be obfuscated when combined with sensor data from other systems.

In addition, privacy can be protected by delaying acting on any particular sensor information until data has been received from a sufficient number of users to ensure no particular user can be identified with sensor data. In some specific examples, such as gathering network access point data, the radius associated with the location of the access point can be expanded such that the dwelling associated with the access point is not determinable.

The environmental features that are detected can be road hazards. Road hazards can include such things as potholes, construction zones, debris on the roadway, snow, ice, flooding (or other water that can cause difficulties while navigating, or anything that may be of interest to a driver passing through the geographic area associated with the remote system.

The environmental features can be associated with failing infrastructure. For example, a smartphone can analyze image data or RADAR data captured in a geographic area around the remote device to determine whether the sidewalks in the area are cracked or uneven. The data can also be analyzed to determine whether other infrastructure components (e.g., a bridge) show signs of potential failure.

The environmental features can also include the presence of adverse traffic conditions or adverse weather conditions. In some examples, the feature data can also include things such as hours of operation for a particular restaurant or business. For example, the camera can detect the absence or presence of light and people within a restaurant. Based on the absence of customers or the presence of customers and light, the feature detection system can determine that the stored hours of operation for the restaurant may be incorrect.

In some examples, the environmental features can include the presence of a large crowd of people. LIDAR data, RADAR data, or camera data can all be used to determine whether or not a large number of users are present in a given geographic location.

The environmental features can also include identified emergency situations. For example, a camera can determine, based on image data, one or more heart rates associated with persons in the environment of the remote device. Heart rate data can be analyzed, along with other indications of potential emergency situations such as fires, smoke, audible screams, sirens, car crashes, and other indications of an emergency, to determine whether an emergency is occurring in the geographic area associated with the remote system.

The feature detection system receives data from one or more remote devices. Each time information associated with an environmental feature is received, the feature detection system determines whether or not the feature is already listed in a feature database. If the feature is not currently listed in the feature database, the feature detection system can add an entry corresponding to the current feature. The feature detection system can also establish a confidence level for that particular feature. In some examples, the initial confidence level is based on the quality of the sensor data and the type of environmental feature. For example, the higher quality the sensor data, the higher the initial confidence level.

In accordance with the determination that there already exists an entry in the feature database for the determined environmental features, the feature detection system updates the confidence level for that particular feature. For example, a feature that is detected by more than one remote operator device will have a higher confidence level than a feature that is only detected by a single remote device. In addition, if a user device passes through a geographic location in which an environmental feature was previously identified and does not determine that that environmental feature currently exists, the confidence level for the particular feature can also be adjusted. In this case, the confidence level can be adjusted to be lower or the entry can be removed entirely from the feature database.

In some examples, the remote computer system performs some data analysis on the captured sensor data and transfers it to the feature detection system to analyze and determine additional information about feature data of interest.

The feature detection system can determine whether the confidence level associated with a particular environmental feature is above a confidence threshold value. The confidence threshold value represents a value of confidence at which the feature detection system determines that it is expedient to take action based on the feature. Thus, the threshold value can be adjusted such that the feature detection system will act either more frequently, when the threshold is lowered, or less frequently, when the threshold is raised.

The action taken by the feature detection system can be determined based on the environmental feature type that has exceeded the threshold value. For example, if the detected feature represents a traffic obstruction or pothole, the feature detection system, or an associated navigation system, can provide an alert to users who are traveling through the location associated with the environmental feature.

In some examples, the feature detection system can update a database of map data. For example, a user can be running an augmented reality application using a computing device. As part of executing the augmented application, the computing device can capture image data of associated with the environment around the computing device (e.g., where the user is pointing the camera). This image data can be used to generate augmented reality overlay data for display to the user while the augmented reality application is being executed. The feature detection system can access the image data (with the appropriate user permissions) that was captured for the augmented reality application (e.g., a first use) and analyze it to determine one or more environmental features associated with the environment around the computing device. The feature detection system can add data representing the determined features to a database of map data. By updating a database of map data with environmental feature data, the feature detection system can cause routes generated by a navigation system to reflect the up-to-date feature information. For example, routes can be generated that avoid traffic hazards or bad traffic.

In some examples, the environmental feature can include infrastructure problems such as a cracked sidewalk or failing bridge. For example, a smartphone can use a RADAR sensor to passively and continuously capture RADAR data for the area around the smartphone. This data can be used to detect the motion controls issued by the user. This sensor data can be accessed by the feature detection system. Using the RADAR data, the feature detection system can identify damage to a nearby road (e.g., a pothole) or sidewalk (e.g., cracked or uneven sidewalks). In this case, the feature detection system can transmit infrastructure data to a local government official to notify them of the potential problem. In other examples, the system can post the information publicly for users to act on as they wish.

If the environmental feature is associated with the business hours of one or more businesses, the feature detection system can update a database of business operation hours to reflect the newly determined business operation hours. In another example, the feature system can send a query to a contact associated with the one or more businesses to receive confirmation of the updated business hours.

The environmental feature can be determined to be the presence of an emergency situation. In this situation, the feature detection system can generate an alert to emergency services providing information about where the emergency is located and what the nature of the emergency may be.

The systems and methods described herein provide a number of technical effects and benefits. More particularly, the systems and methods of the present disclosure provide improved techniques for detecting and responding to features detected in a given environment. For instance, by using data already gathered by computing devices for other purposes, the disclosed system can result in significant savings in processing time and power usage since it is not necessary to re-gather the data for a different purpose. In addition, the data obtained by performing this extra analysis can enhance the accuracy of data in a map database, resulting in more efficient and safe navigation routes.

With reference now to the Figures, example embodiments of the present disclosure will be discussed in further detail.

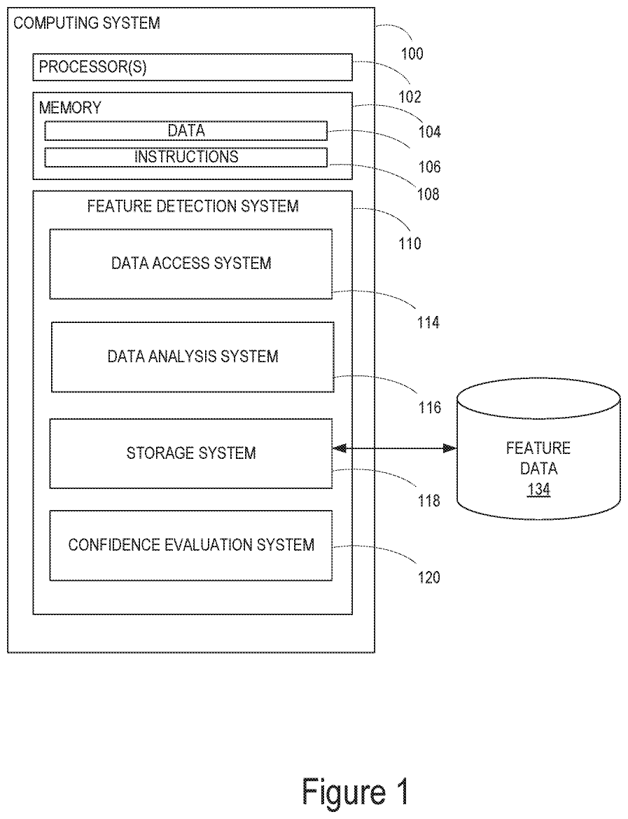

FIG. 1 depicts an example computing environment for a feature detection system 110 according to example embodiments of the present disclosure. FIG. 1 illustrates one example of a computing system 100 that can be used to implement the present disclosure. Other computing systems that include different components can be used in addition or alternatively to the computing system 100.

The computing system 100 can be any type of computing device, such as, for example, a personal computing device (e.g., laptop or desktop), a server computing device, or any other type of computing device. The computing system 100 includes one or more processors 102 and one or more memories 104. The one or more processors 124 can be any suitable processing device (e.g., a processor core, a microprocessor, an ASIC, a FPGA, a controller, a microcontroller, etc.) and can be one processor or a plurality of processors that are operatively connected. The memory 104 can include one or more non-transitory computer-readable storage mediums, such as RAM, ROM, EEPROM, EPROM, flash memory devices, magnetic disks, etc., and combinations thereof. The memory 104 can store data 106 and instructions 108 which are executed by the processor 102 to cause the computing device 100 to perform operations, including one or more of the operations disclosed herein.

According to aspects of the present disclosure, the computing system 100 can include a feature detection system 110 for identifying features in a geographic location near the computing system 100 (or a remote computing system in communication with the feature detection system 110). The feature detection system 110 can access data gathered by sensors for a primary use that is distinct from feature detection and analyze that data to determine one or more features in the area associated with the accessed data. To perform this task, the feature detection system 110 can include a plurality of subsystems. The subsystems can include a data access system 114, a data analysis system 116, a storage system 118, and a confidence evaluation system 120. One or more of the subsystems can access data from and store data in the feature database 130.

The data access system 114 can access sensor data gathered by sensors associated with the computing system 100 or with a remote computing system. In some examples, the data access system 114 can access data gathered by a camera sensor, a RADAR sensor, a LIDAR sensor, a WIFI transceiver, a microphone (or another audio sensor), a laser sensor (disparity based, structured lighting, and/or Time of Flight sensors), or other sensor. This sensor data can be gathered by one of the sensors for a first use. For example, a camera sensor can be associated with enabling an augmented reality application (by capturing live image data that can be augmented for display on the user device).

The data access system 114 can access this data (with permission from a user) for use in the feature detection system (e.g., a secondary use unrelated to a first use). In some examples, the accessed sensor data has been processed prior to being accessed by the data access system 114 or compressed for transmission over a network. The sensor data can be transmitted to the data analysis 116 for analysis.

The data analysis system 116 can process the received image data to identify one or more environmental features. Geographic features can include objects, hazards, crowds of people, states of traffic, information describing current weather, and so on.

The method used to detect environmental features in the sensor data can depend on the specific data type that is received. For example, if the sensor data is audio data, the data analysis system can analyze the audio data for sounds that are indicative of environmental features that can be determined based on audio data. For example, the data analysis system 116 can determine crowd sizes based on the volume or composition of the audio data. Similarly, the audio data can be analyzed for sounds indicative of an emergency situation (e.g., screaming, sirens, and so on).

Data received from a camera (or another image sensor) can be analyzed using standard computer vision techniques to identify objects within the images and characteristics of those objects. For example, the image data can be analyzed to identify objects, people, conditions, and so on. LIDAR and RADAR sensor data can be analyzed to determine one or more objects.

A variety of different environmental features can be identified by the data analysis system 116 using the sensor data. For example, the environmental features that are detected can be road hazards. Road hazards can include such things as potholes, construction zones, debris on the roadway, or anything that may be of interest to a driver passing through the geographic area associated with the remote system.

The environmental features can be associated with failing infrastructure. For example, the data analysis system 116 can analyze image data or RADAR data captured in a geographic area around the remote device to determine whether the sidewalks in the area are cracked or uneven. The data can also be analyzed by the data analysis system 116 to determine whether other infrastructure components (e.g., a bridge) show signs of potential failure.

In some examples, a laser scan data of the road surface and surrounding sidewalk surfaces (originally for vehicle localization and mapping purposes) can be gathered and use to alert users of road hazards such as potholes. In the case of sidewalks, broken concrete can be detected, with the signals are augmented using techniques such as Kalman Filters where sensor fusion between, for instance, radar and laser signals can be combined to get a more accurate prediction of position and motion, for both a vehicle (or pedestrian) and also stationary obstructions in the road. Being able to detect broken concrete and other tripping hazards is useful for navigation services like Google Maps, in order to alert joggers, the blind or hard of seeing, or otherwise unaware pedestrians following navigation directions. Similarly, detecting and alerting about road hazards would save damage on many users' vehicles following the route (and allow re-routes to avoid any potential hazards).

The environmental features can also include the presence of adverse traffic conditions or adverse weather conditions. In some examples, the feature data can also include things such as hours of operation for a particular restaurant or business. For example, the camera can detect the absence or presence of light and people within a restaurant. Based on the absence of customers or the presence of customers and light, the data analysis system 116 can determine that the stored hours of operation for the restaurant may be incorrect.

In some examples, the environmental features can include the presence of a large crowd of people. LIDAR data, RADAR data, or camera data can all be used to determine whether or not a large number of users are present in a given geographic location.

The environmental features can also include identified emergency situations. For example, data captured by a camera can be analyzed to determine, based on the image data, one or more heart rates associated with persons in the environment of the remote device. Heart rate data can be analyzed, along with other indications of potential emergency situations such as fires, smoke, audible screams, car crashes, and other indications of an emergency, to determine whether an emergency is occurring in the geographic area associated with the remote system.

The remote devices can use the data captured from the sensors for a first use. For example, as noted above, a user can use the camera on their smartphone to take a selfie. In some examples, the primary use of the captured sensor data may include launching an application associated with the primary use. For example, the user may launch a camera application to use the camera to capture image data or video data.

The first (or primary) use of the sensor data may not involve explicitly launching an application. Instead, the first use of the sensor data may be associated with passively monitoring the data captured by the sensor and monitoring that data for one or more situations in which the smartphone or other device needs to respond. For example, a smartphone may include a RADAR sensor. The RADAR sensor can constantly monitor the motion of objects near the smartphone and determine when or if a user is making a hand gesture associated with unlocking the device. For example, a user may make one or more hand gestures near the smartphone. A particular hand gesture can, for example, be associated with unlocking the smartphone for use.

Another example of a first use can be an augmented reality application. Using such an application, a camera associated with a computing device can be active and capture image data of the environment around the device so that a view of the environment, shown on a display associated with a device, can be altered such that objects not present in the environment are displayed. The environmental image data being captured by the camera can include a view of a road surface or other features of the environment. As a result, this data can be analyzed to determine whether any environmental features can be identified.

Similarly, another first use can include passively monitoring audio data using a microphone to enable the use of voice commands from a user to control the computing device. This audio data can be analyzed to determine sound levels in the environment. These sound levels can be analyzed to estimate crowd sizes and determine the status of businesses (e.g., open, closed, busy, and so on).

A computing device can also include a transceiver for wireless signals (e.g., WIFI) which allow the computing device to communicate via a network. In some examples, the wireless signals can be body reflective and thus can be analyzed to determine the number of individuals in a given area.

In some examples, camera data can be analyzed to determine health data for individuals within the environment of the computing device. For instance, photoplethysmography (PPG) can be used to detect and measure heart rate with some accuracy through RGB images (e.g., images that can be captured by a camera). This data, when properly anonymized, crowd-sourced, and privatized, can be used to aide in the understanding of health experiments/studies/datasets where, for instance, average heart rate is a useful statistic to know at various times of day, year/season, location, and/or with/without knowledge of various activities going on nearby. In some examples, the elevated heart-rate can be analyzed and used as an indication of the presence of a potential disturbance, road condition, and so on (from an otherwise stressful commuting or pedestrian event).

Once the data has been used for the first use of the remote computing device, the data may also be used for a secondary purpose. For example, data gathered for a first purpose can later be analyzed to determine whether any environmental features can be determined based on the data. In some examples, the sensor data is transmitted to a feature detection system that is remote from the user device. However, transmitting raw sensor data can consume so much bandwidth or take so much time that it is not feasible. As such, the remote system itself can include the ability to analyze sensor data for the second use and determine any environmental features that may be locatable.

Once the data analysis system 116 has identified one or more environmental features, data describing the one or more environmental features can be transmitted to a storage system 118. The storage system 118 can be associated with maintaining data in a feature database 130. The feature database 130 can be included in a database of geographic data.

The database can include geographic data associated with geographic locations and their environments. The geographic data can include data describing roads, buildings, landmarks, traffic information, and other data useful for navigating through geographic space. In some examples, the feature database 130 can include a plurality of environmental features entries. Each entry describes the specific environmental feature and associated information, including, but not limited to, the location associated with the environmental feature, the environmental feature type, and so on.

The storage system 118 can, when it receives data associated with one or more environmental features, determine, for each feature, whether an entry for that feature currently exists in the feature database. If so, the storage system 118 can transmit information about the environmental feature to the confidence evaluation system 120. If there is no current entry in the feature database 130, the storage system 118 can create an entry for the environmental feature.

The confidence evaluation system 120 can determine, based on the information associated with the environmental feature, a confidence level associated with the environmental feature. The confidence level can represent the degree to which the confidence evaluation system 120 is confident that the particular environmental feature indeed exists at the location for which it is listed. In some examples, the initial confidence level is based on the quality of the sensor data and the type of environmental feature.

In accordance with the determination that an entry for the environmental feature exists in the feature database for the determined environmental features, the confidence evaluation system 120 can update the confidence level for that particular feature. For example, a feature that is detected by more than one computing device will have a higher confidence level than a feature that is only detected by a single remote device. In addition, if a computing device passes through a geographic location in which an environmental feature was previously identified and does not determine that that environmental feature currently exists, the confidence level for the particular feature can also be adjusted to reflect lowered confidence (or the entry can be removed entirely from the feature database.)

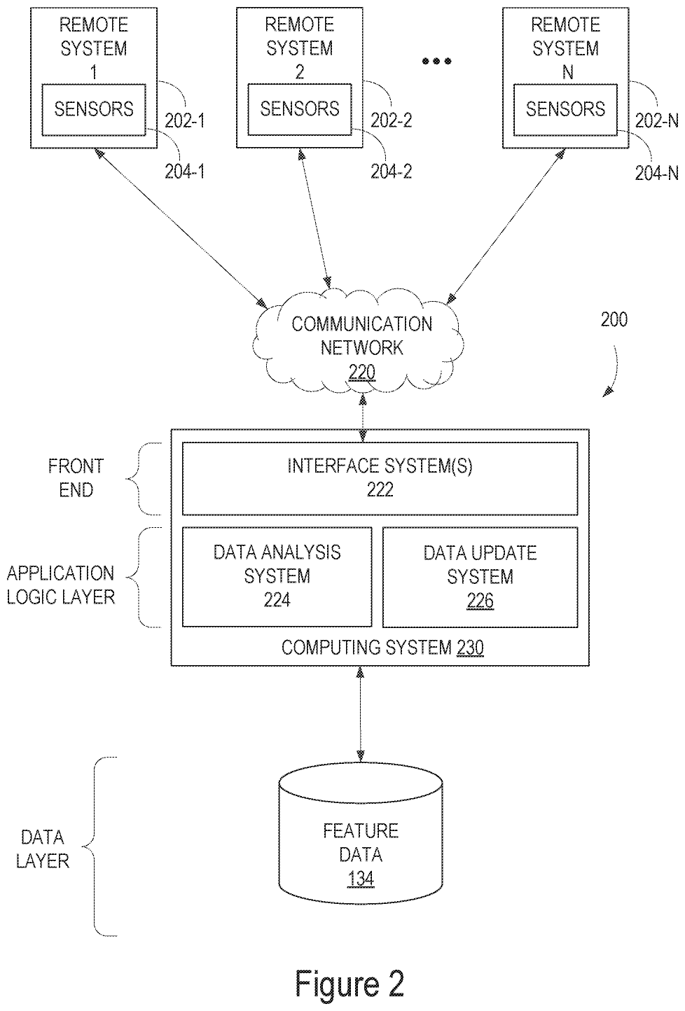

FIG. 2 depicts an example client-server environment according to example embodiments of the present disclosure. The client-server system environment 200 includes one or more remote systems (202-1, 202-2, and 202-N) and the computing system 220. One or more communication networks 220 can interconnect these components. The communication networks 220 may be any of a variety of network types, including local area networks (LANs), wide area networks (WANs), wireless networks, wired networks, the Internet, personal area networks (PANs), or a combination of such networks. It should be noted that FIG. 2 includes a plurality of remote systems, each labeled with a distinctive reference number (202-1, 202-2, and 202-N). However, when referring to a remote system generally, rather than a specific depicted remote system, the general reference number 202 can be used.

A remote system 202 can be an electronic device, such as a personal computer (PC), a laptop, a smartphone, a tablet, a mobile phone, an electrical component of a vehicle or any other electronic device capable of communication with the communication network 220. A remote system 202 includes one or more sensors 204, which capture data for the remote system 202. The sensors can include one or more of an image sensor, an audio sensor, a RADAR sensor, a LIDAR sensor, a WIFI transceiver, and so on.

The remote system 202 can include an application for communication with the computing system 230. In some examples, the computing system can be a server system that is associated with one or more services.

A remote system 202 can collect sensor data from the environment around the system using one or more sensors 204. The collected sensor data can be transmitted to the computing system 230 for analysis. In some examples, the remote system 202 can extract feature information from the sensor data before transmitting to the computing system 230 to conserve used bandwidth.

As shown in FIG. 2, the computing system 230 is generally based on a three-tiered architecture, consisting of a front-end layer, application logic layer, and data layer. As is understood by skilled artisans in the relevant computer and Internet-related arts, each component shown in FIG. 2 can represent a set of executable software instructions and the corresponding hardware (e.g., memory and processor) for executing the instructions. To avoid unnecessary detail, various components and engines that are not germane to conveying an understanding of the various examples have been omitted from FIG. 2. However, a skilled artisan will readily recognize that various additional components and engines may be used with a computer system 230, such as that illustrated in FIG. 2, to facilitate additional functionality that is not specifically described herein. Furthermore, the various components depicted in FIG. 1 may reside on a single server computer or may be distributed across several server computers in various arrangements. Moreover, although the computer system 230 is depicted in FIG. 2 as having a three-tiered architecture, the various example embodiments are by no means limited to this architecture.

As shown in FIG. 2, the front end consists of an interface system(s) 222, which receives communications from various remote systems 202 and communicates appropriate responses to the remote systems 202. For example, the interface system(s) 222 may receive requests in the form of Hypertext Transfer Protocol (HTTP) requests, or other web-based, application programming interface (API) requests. The remote system 202 may be executing conventional web browser applications or applications that have been developed for a specific platform to include any of a wide variety of mobile devices and operating systems.

As shown in FIG. 2, the data layer includes a feature database for storing geographic data associated with geographic locations and the environments associated with the geographic locations. The geographic data can include data describing roads, buildings, landmarks, traffic information, and other data useful for navigating through geographic space. In some examples, the feature database 130 can include a plurality of environmental features entries. Each entry describes the specific environmental feature and associated information, including, but not limited to, the location associated with the environmental feature, the environmental feature type, and so on.

The computing system 230 may provide a broad range of other applications and services that allow users to access or receive geographic data for navigation or other purposes. The computing system can include a data analysis system 224 and a data update system 226.

Generally, the data analysis system 224 can access sensor data received from one or more remote systems 202. In some examples, the data analysis system 224 can receive raw sensor data. In other examples, the data analysis system 224 can receive data that has been compressed or processed to extract relevant feature data. In this way, the total amount of data that needs to be transmitted can be significantly reduced.

The data analysis system 224 can determine one or more environmental features based on the sensor data. As noted above, the method used to detect environmental features can depend on the specific data type that is received. For example, if the sensor data is audio data, the data analysis system can analyze the audio data for sounds that are indicative of environmental features that can be determined based on audio data. For example, the data analysis system 116 can determine crowd sizes based on a volume or composition of the audio data. Similarly, the audio data can be analyzed for sounds indicative of an emergency situation (e.g., screaming, sirens, and so on).

Data received from a camera (or another image sensor) can be analyzed using standard computer vision techniques to identify objects within the images and characteristics of those objects. For example, the image data can be analyzed to identify objects, people, conditions and so on. LIDAR and RADAR sensor data can be analyzed to determine one or more objects.

The data analysis system 224 can transmit data associated with each determined environmental feature to the data update system 226. The data update system 226 can determine, for each environmental feature, whether the environmental feature is already stored in the feature data. The data update system 226 can, if the environmental feature is not already included in the feature database 130, create an entry for the environmental feature. In some examples, the entry includes information about the confidence level that the environmental feature actually exists, the location of the geographic information, the type of environmental feature, and so on.

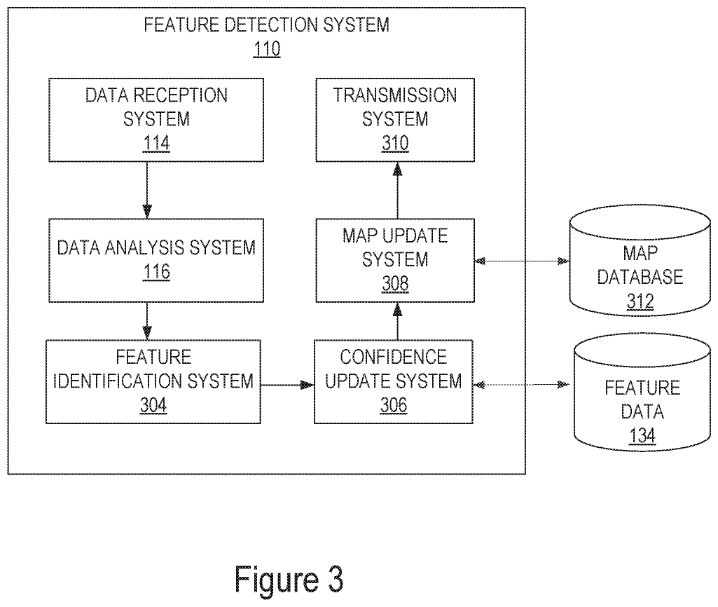

FIG. 3 depicts a block diagram of a feature detection system according to example embodiments of the present disclosure. The feature detection system 120 can include a data reception system 114, a data analysis system 116, a feature identification system 304, a confidence update system 306, a map update system 308, and a transmission system 310.

As noted above, the data reception system 114 can receive or access sensor data associated with an environment around a computing device. The sensor data can be transmitted to the data analysis system 116. The data analysis system 116 can identify one or more features within the sensor data. The feature identification system 304 can determine the specific attributes of the environmental feature based on the information provided by the data analysis system 116.

The confidence update system 306 can adjust a confidence value associated with each feature identified by the feature update system three or four. For example, if a specific environmental feature is identified by an additional computing device or remote device, or by a higher quality sensor, the confidence update system can increase the confidence value associated with that environmental feature. Similarly, if an expected environmental feature is either not detected or is detected in a matter that makes it less likely to exist, the confidence value associated with that environmental feature can be reduced by the confidence update system 306.

Once the environmental feature information in the feature database 130 has been updated, the map update system 308 can update map data in a map database 312. For example, if an obstacle is determined to exist at a particular geographic location, the map database 312 can be updated to reflect that obstacle in the map database 312. For example, if a route is planned using the map data, the route may be adjusted to avoid the known obstacle.

In some examples, the environmental feature can be determined to be of such importance that data concerning the environmental feature can be transmitted to one or more outside systems or people. For example, if sensor data reveals that a particular section of sidewalk has been badly damaged, such that it poses either danger to passersby or fails to provide accessibility for people who may require smooth surfaces, the transmission system 310 can transmit a notification to an appropriate public official.

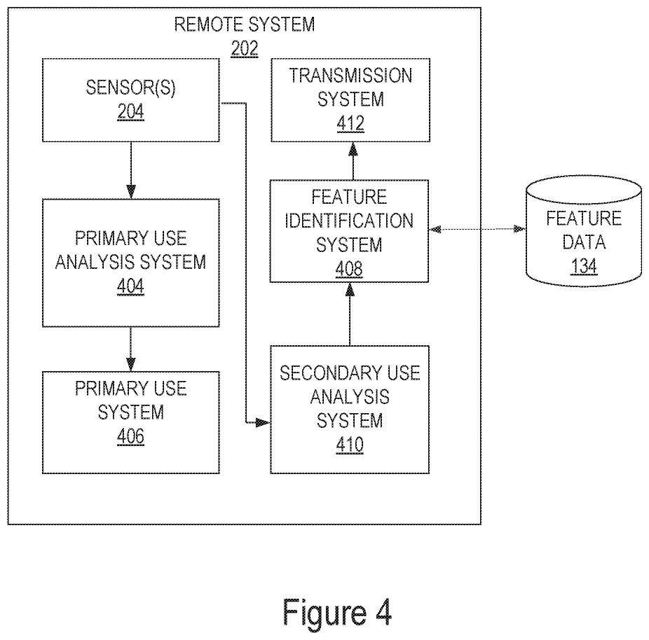

FIG. 4 depicts a block diagram of a remote system 202 according to example embodiments of the present disclosure. The remote system can be a computer system located remotely from a server system. A remote system 202 can be an electronic device, such as a personal computer (PC), a laptop, a smartphone, a tablet, a mobile phone, an electrical component of a vehicle or any other electronic device.

The remote system can include one or more sensors 204, a primary use analysis system 404, a primary use system 406, a feature identification system 408, a secondary use analysis system 410, and a transmission system 412. The remote system can also interact with a feature database 134.

The remote system 202 includes one or more sensors 204, which capture data for the remote system 202. The sensors can include one or more of an image sensor, an audio sensor, a RADAR sensor, a LIDAR sensor, a WIFI transceiver, and so on.

In some examples, the sensor can transmit sensor data to primary use analysis system 404. The primary use analysis system 404 can include any system that processes the data produced by the sensors 204 for a particular primary use. The primary use analysis system 404 can transmit the analyzed data to a primary use system 406.

The remote system 202 can use the data captured from the sensors 204 for a first use. For example, as noted above, a user can use the camera on their smartphone to take a selfie. In some examples, the primary use of the captured sensor data may include launching an application associated with the primary use. For example, the user may launch a camera application that employs the camera to capture image data or video data.

The first (or primary) use of the sensor data may not involve explicitly launching an application. Instead, the first use of the sensor data may be associated with passively monitoring the data captured by the sensor and monitoring that data for one or more situations in which the smartphone or other computing device needs to respond. For example, a smartphone may include a RADAR sensor. The RADAR sensor can constantly monitor the motion of objects near the smartphone and determine when or if a user is making a hand gesture associated with unlocking the device. For example, a user may make one or more hand gestures near the smartphone. A particular hand gesture can, for example, be associated with unlocking the smartphone for use.

Another example of a first use can be an augmented reality application. Using such an application, a camera associated with a computing device is active and captures image data of the environment around the device so that a view of the environment, shown on a display associated with a device, can be altered such that objects not present in the environment appear in the display. The image data being captured by the camera can include a view of a road surface or other features of the environment. As a result, this data can be analyzed to determine whether any environmental features can be identified in the image data.

Similarly, another first use can passively monitor audio data using a microphone to enable the use of voice commands from a user to control the computing device. This audio data can be analyzed to determine sound levels in the environment. These sound levels can be analyzed to estimate crowd sizes and determine the status of businesses (e.g., open, closed, busy, and so on).

A computing device can also include a transceiver for wireless signals (e.g., WIFI) which allow the computing device to communicate via a network. In some examples, the wireless signals can be body reflective and thus can be analyzed to determine the number of individuals in a given area.

The remote system 202 can also include a secondary use analysis system 410. The secondary use analysis system 410 can analyze the sensor data received from the sensors 204 to determine one or more features relevant to a secondary use (in this case, feature detection). Once the secondary use analysis system 410 has analyzed the sensor data, the secondary use analysis system 410 can transmit the analyzed sensor data (e.g., information that has been extracted and/or condensed from the sensor data) to the feature identification system 408. The feature identification system 408 can use the analyzed sensor data to determine one or more environmental features in the area of the remote system 202. In some examples, the feature identification system 408 can access data from the feature database 134 or transmit to the feature database 134.

In some examples, the feature identification system 408 can determine that a notification needs to be sent to one or more other systems (to notify another person or organization that an issue has occurred at a specific geographic location). In response, the feature identification system 408 can transmit the associated data to the transmission system 412. The transmission system 412 can transmit one or more alerts to users in a geographic area associated with the remote devices.

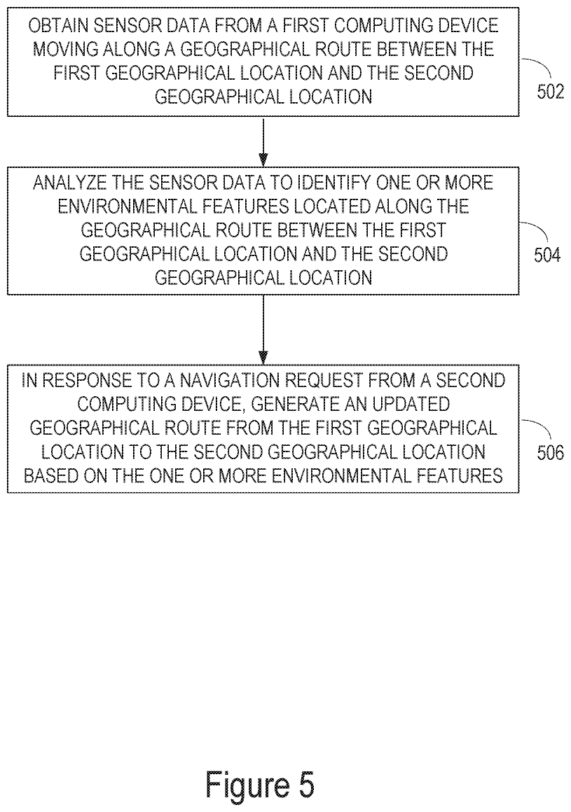

FIG. 5 depicts a flow chart of an example method 500 for identifying features in an environment according to example embodiments of the present disclosure. One or more portions of method 500 can be implemented by one or more computing devices such as, for example, a computing device of feature detection system 110 as depicted in FIG. 1. One or more portions of the method 500 described herein can be implemented as an algorithm on the hardware components of the devices described herein (e.g., as in FIG. 1, FIG. 2, FIG. 3, and FIG. 4) to, for example, to identify environmental features and update data stored in a database. Although FIG. 5 depicts steps performed in a particular order for purposes of illustration and discussion, method 500 of FIG. 5 is not limited to the particularly illustrated order or arrangement. The various steps of the methods disclosed herein can be omitted, rearranged, combined, and/or adapted in various ways without deviating from the scope of the present disclosure.

A feature detection system (e.g., feature detection system 110 in FIG. 1) can obtain, at 502, sensor data from a first computing device moving along a geographical route between the first geographical location and the second geographical location. In some examples, the sensor data was previously obtained, and stored in a database, for a purpose other than for the step of analyzing the sensor data to identify one or more environmental features associated with the intermediate geographical location. The step of obtaining sensor data can comprise obtaining the sensor data from the database.

A feature detection system (e.g., feature detection system 110 in FIG. 1) can, at 504, analyze the sensor data to identify one or more environmental features located along the geographical route between the first geographical location and the second geographical location.

In some examples, the feature detection system (e.g., feature detection system 110 in FIG. 1) can obtain sensor data from a plurality of computing devices including the first computing device, associated with the geographical location associated with the one or more environmental features. The feature detection system (e.g., feature detection system 110 in FIG. 1) can determine that a threshold number of the plurality of computing devices identify the one or more environmental features before updating the stored map data.

The feature detection system (e.g., feature detection system 110 in FIG. 1) can update a geographic database to include the one or more environmental features. For example, a database of map data can be updated to include information associated with the one or more environmental features.

The feature detection system (e.g., feature detection system 110 in FIG. 1) can, in response to a navigation request from a second computing device, generate, at 506, an updated geographical route from the first geographical location to the second geographical location based on the one or more environmental features. In some examples, the updated geographical route does not include a geographical location associated with the one or more environmental features. The feature detection system (e.g., feature detection system 110 in FIG. 1) can transmit the updated geographical route to the second computing device.

In another example, the feature detection system (e.g., feature detection system 110 in FIG. 1) can obtain sensor data for a first use from sensors on a user computing device. In some examples, the sensor is a RADAR sensor and the first use is motion control detection. In other examples, the sensor is a camera and the first use is capturing images of a user and their surroundings. In yet other examples, the user computing device is a smartphone. In some examples, the user computing device is associated with a vehicle.

In some examples, the first use can comprise passively monitoring the sensor data to determine whether a user is interacting with the user computing device. In some examples, the sensor is a RADAR sensor and the first use is motion control detection. In some examples, the sensor is a camera and the first use is capturing images of a user and their surroundings. In some examples, the sensor is a LIDAR sensor and the first use is object detection for use while navigating a vehicle.

The feature detection system (e.g., feature detection system 110 in FIG. 1) can analyze, sensor data to determine information associated with the first use. The feature detection system (e.g., feature detection system 110 in FIG. 1) can launch a first application associated with the first use. For example, the system can launch a camera application to capture image data of a user's environment.

The feature detection system (e.g., feature detection system 110 in FIG. 1) can process, using the first application, the sensor data based on the first use. For example, the camera application can receive image data from a camera and process it for display on the display associated with the feature detection system (e.g., feature detection system 110 in FIG. 1). The feature detection system (e.g., feature detection system 110 in FIG. 1) can launch a second application for identifying one or more environmental features using the sensor data.

The feature detection system (e.g., feature detection system 110 in FIG. 1) can analyze sensor data to identify one or more environmental features for the geographical location around the computing system, wherein the first use is distinct from identifying environmental features. In some examples, the environmental features include one or more of: structural problems with a sidewalk in the environment of the computing system, the operational schedule of one or more businesses in the environment of the computing system, the presence of a large crowd, and indications of an emergency situation.

The feature detection system (e.g., feature detection system 110 in FIG. 1) can transmit data indicative of the one or more environmental features to a remote server to store in an environmental feature database.

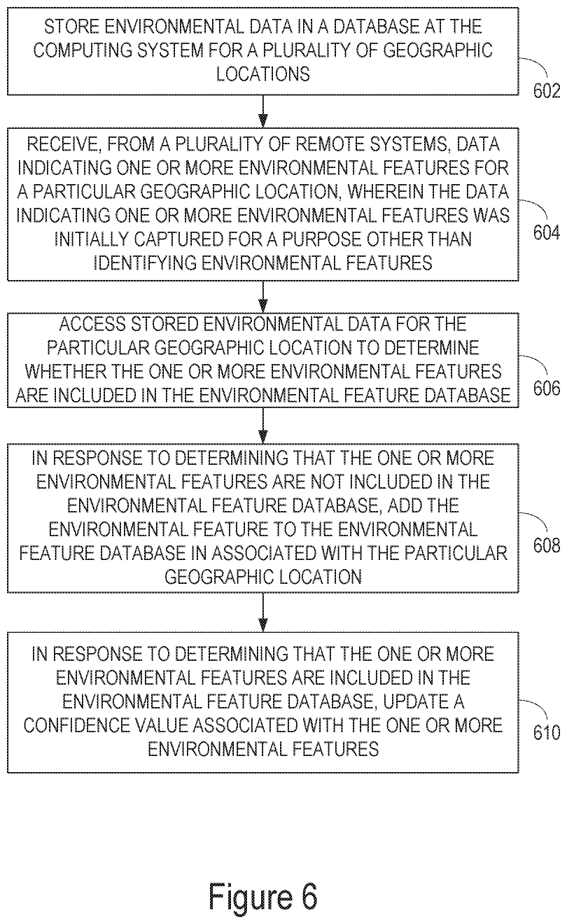

FIG. 6 depicts a flow chart of an example method for managing a map database according to example embodiments of the present disclosure. One or more portions of method 600 can be implemented by one or more computing devices such as, for example, a computing device of computing system as depicted in FIG. 2. One or more portions of the method 600 described herein can be implemented as an algorithm on the hardware components of the devices described herein (e.g., as in FIG. 1, FIG. 2, FIG. 3, and FIG. 4) to, for example, to identify environmental features and update data stored in a database. Although FIG. 6 depicts steps performed in a particular order for purposes of illustration and discussion, method 600 of FIG. 6 is not limited to the particularly illustrated order or arrangement. The various steps of the methods disclosed herein can be omitted, rearranged, combined, and/or adapted in various ways without deviating from the scope of the present disclosure.

The computer system (e.g., computer system 230 in FIG. 2) can, at 602, store environmental data in a database at the computing system for a plurality of geographic locations. The computer system (e.g., computer system 230 in FIG. 2) can, at 604, receive, from a plurality of remote systems, data indicating one or more environmental features for a particular geographic location, wherein the data indicating one or more environmental features was initially captured for a purpose other than identifying environmental features.

In some examples, the computer system (e.g., computer system 230 in FIG. 2) can, at 606, access stored environmental data for the particular geographic location to determine whether the one or more environmental features are included in the environmental feature database. In response to determining that the one or more environmental features are not included in the environmental feature database, the computer system (e.g., computer system 230 in FIG. 2) can, at 608, add the environmental feature to the environmental feature database in associated with the particular geographic location. In response to determining that the one or more environmental features are included in the environmental feature database, the computer system (e.g., computer system 230 in FIG. 2) can, at 610, update a confidence value associated with the one or more environmental features.

In some examples, the computer system (e.g., computer system 230 in FIG. 2) can determine whether the confidence value associated with the one or more environmental features exceeds a threshold value. In response to determining that the confidence value associated with the one or more environmental features exceeds the threshold value, the computer system (e.g., computer system 230 in FIG. 2) can update stored map data associated with the particular geographic location.

The computer system (e.g., computer system 230 in FIG. 2) can determine whether the confidence value associated with the one or more environmental features exceeds a threshold value. In response to determining that the confidence value associated with the one or more environmental features exceeds the threshold value, the computer system (e.g., computer system 230 in FIG. 2) can generate an infrastructure damage report for transmission to a third-party system. In some examples, the third-party system can be associated with a government agency.

The computer system (e.g., computer system 230 in FIG. 2) can determine whether the confidence value associated with the one or more environmental features exceeds a threshold value. In response to determining that the confidence value associated with the one or more environmental features exceeds the threshold value, the computer system (e.g., computer system 230 in FIG. 2) can transmit an alert to an emergency services system.

The computer system can determine whether the confidence value associated with the one or more environmental features exceeds a threshold value. In response to determining that the confidence value associated with the one or more environmental features exceeds a threshold value, the computer system (e.g., computer system 230 in FIG. 2) can update the stored operational schedule of one or more businesses in the environment of a remote system in the plurality of remote systems.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of updating a geographical route between a first geographical location and a second geographical location, the method comprising:
obtaining, by a computing system including one or more processors, sensor data from a first computing device moving along a geographical route between the first geographical location and the second geographical location;
analyzing, by the computing system, the sensor data to identify one or more environmental features located along the geographical route between the first geographical location and the second geographical location; and
in response to a navigation request from a second computing device, generating, by the computing system, an updated geographical route from the first geographical location to the second geographical location based on the one or more environmental features.

2. The computer-implemented method of claim 1, wherein the updated geographical route does not include a geographical location associated with the one or more environmental features.

3. The computer-implemented method of claim 1, further comprising transmitting the updated geographical route to the second computing device.

4. The computer-implemented method of claim 1, wherein the step of obtaining sensor data further comprises obtaining, by the computing system and from a plurality of computing devices including the first computing device, sensor data associated with the geographical location associated with the one or more environmental features.

5. The computer-implemented method of claim 4, wherein the step of analyzing the sensor data to identify one or more environmental features further comprises:
determining, by the computing system, that a threshold number of the plurality of computing devices identify the one or more environmental features before updating the stored map data.

6. The computer-implemented method of claim 1, the method further comprising:
updating, by the computing system, a geographic database to include the one or more environmental features.

7. The computer-implemented method of claim 1, wherein the sensor data was previously obtained, and stored in a database, for a purpose other than for the step of analyzing the sensor data to identify one or more environmental features located along the geographical route between the first geographical location and the second geographical location.

8. The computer-implemented method of claim 7, wherein the step of obtaining sensor data further comprises obtaining the sensor data from the database.

9. A system for receiving environmental data from device sensors, the system comprising:
a computing system comprising one or more processors and a non-transitory computer-readable memory;
wherein the non-transitory computer-readable memory stores instructions that, when executed by the processor, cause the computing system to perform operations, the operations comprising:
storing environmental data in an environmental feature database at the computing system for a plurality of geographic locations;
receiving, from one or more remote systems, data indicating one or more environmental features for a particular geographic location;
accessing stored environmental data for the particular geographic location to determine whether the one or more environmental features are included in the environmental feature database;
in response to determining that the one or more environmental features are included in the environmental feature database, updating a confidence value associated with the one or more environmental features; and
in response to determining that the one or more environmental features are not included in the environmental feature database, adding the environmental feature to the environmental feature database in associated with the particular geographic location.

10. The system of claim 9, the operations further comprising:
determining whether the confidence value associated with the one or more environmental features exceeds a threshold value; and
in response to determining that the confidence value associated with the one or more environmental features exceeds the threshold value, updating stored map data associated with the particular geographic location.

11. The system of claim 1, the operations further comprising:
determining whether the confidence value associated with the one or more environmental features exceeds a threshold value; and
in response to determining that the confidence value associated with the one or more environmental features exceeds the threshold value, generating an infrastructure damage report for transmission to a third-party system.

12. The system of claim 11, wherein the third-party system is associated with a government agency.

13. The system of claim 1, the operations further comprising:
determining whether the confidence value associated with the one or more environmental features exceeds a threshold value; and
in response to determining that the confidence value associated with the one or more environmental features exceeds the threshold value, transmitting an alert to an emergency services system.

14. The system of claim 1, the operations further comprising:
determining whether the confidence value associated with the one or more environmental features exceeds a threshold value; and
in response to determining that the confidence value associated with the one or more environmental features exceeds a threshold value, updating a stored operational schedule of one or more businesses in the environment of a remote system in the plurality of remote systems.

15. A non-transitory computer-readable medium storing instruction that, when executed by one or more computing devices, cause the one or more computing devices to perform operations, the operations comprising:
obtaining sensor data from a first computing device moving along a geographical route between the first geographical location and the second geographical location;
analyzing the sensor data to identify one or more environmental features located along the geographical route between the first geographical location and the second geographical location; and
in response to a navigation request from a second computing device, generating an updated geographical route from the first geographical location to the second geographical location based on the one or more environmental features.

16. The non-transitory computer-readable medium of claim 15, wherein the user computing device is a smartphone.

17. The non-transitory computer-readable medium of claim 1, wherein the sensor data is obtained for a first use distinct from identifying environmental features

18. The non-transitory computer-readable medium of claim 1, wherein the first use comprises passively monitoring the sensor data to determine whether a user is interacting with the user computing device.

19. The non-transitory computer-readable medium of claim 1, wherein the user computing device is associated with a vehicle.

20. The non-transitory computer-readable medium of claim 19, wherein the sensor is a LIDAR sensor and the first use is object detection for use while navigating the vehicle.
